(19) United States
(12) Patent Application Publication
(10) Pub. No.: US 2008/0224844 A1
(43) Pub. Date: Sep. 18, 2008

(54) Mobile safety light

(76) Inventors: Rhoderick Dwight Hall, Temple, GA (US); Karman Monique Parham, North Port, AL (US); Martressa Nicholette Hall, Douglassville, GA (US)

Correspondence Address: Rhoderich Dwight Hall, 205 James Allen PL, Temple, GA, 30179, US

(21) Appl. No.: 11/716,871

(22) Filed: Mar. 12, 2007

(51) Int. Cl. B60Q 7/00

(52) U.S. Cl. 340/473

(57) ABSTRACT

I Rhoderick Dwight Hall has invented the Mobile Safety Light as set forth in the following Abstracts.

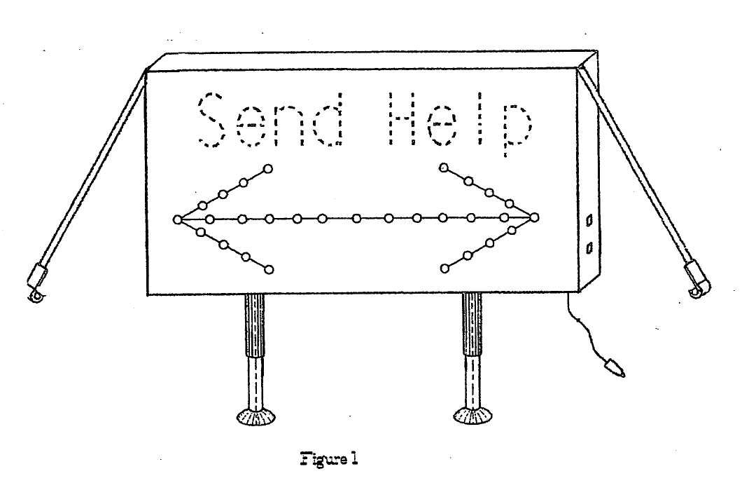

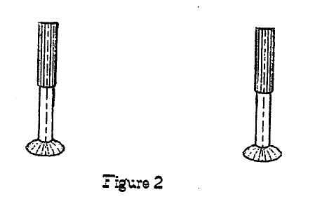

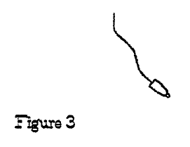

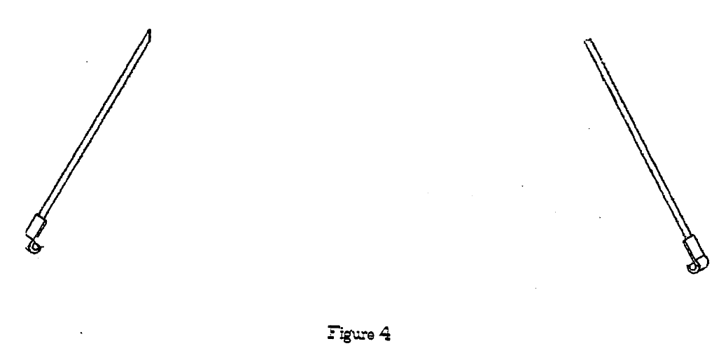

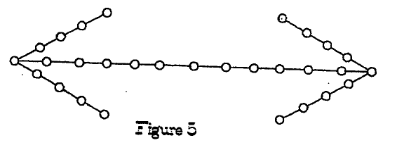

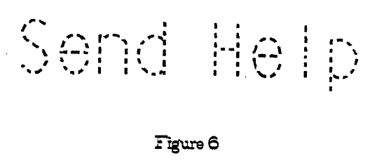

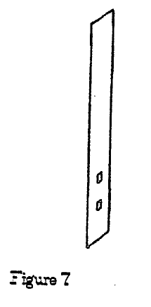

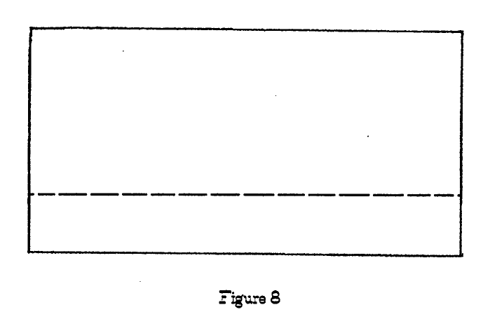

Abstract 1 is a front prospective view of the Mobile Safety Light of the present invention;
Abstract 2 is a rear view panel of the Mobile Safety Light;
Abstract 3 is a side view of the Off and On switch and the view of the Directonal Arrow button thereof;
Abstract 4 is a front view of the L.E.D. message thereof;
Abstract 5 is a front view of the Directional Arrows thereof;
Abstract 6 is a front view of the Elastic/Bungee Cord with attached secure hooks thereof;
Abstract 7 is a front view of the Auxiliary Power Cord thereof;
Abstract 8 is a front view of the Extendable Legs thereof;

Directional Arrow: These arrows will be used to direct the oncoming traffic to move into a safer Lane.

English Language: The primary language for the Mobile Safety Light will be English, yet it will Have the ability to be changed to your native language.

Elastic Cord: The elastic/bungee cord will be used to secure the Mobile Safety Light on the roof or the tire well of any vehicle. The elastic cord/bungee cord will assist securing the Mobile Safety Light into a steady position.

Suction Cups The suction cup or magnet will be attached to the end of the adjustable legs which will add more stability when the Mobile Safety Light is deployed.

Magnet Stabilizer: The Magnet Stabilizer will assist securing the Mobile Safety Light when Placed into position.

Protection Cloth: Protection Clothe will be added to the end of the Magnet Stabilizers, to Protect the paint on your Vehicle

Adjustable: The adjustable leg may have the ability to be adjusted from one-two feets.

Legs: By adjusting the leg, it will give the oncoming traffic more distance to See that a person is having vehicular problems up ahead. The Oncoming drives will be able to sees the L.E.D. lights about 200 Yards. To 200 yard distant will give the oncoming driver time to think and make a Safe decision to prevent an accident or maybe a fatality.

L.E.D. Display: The L.E.D. Display will be used to direct the oncoming traffic which Lane the pedestrian with vehicular problem wants them to move to. The L.E.D. Display will also be able to send a visible message “SEND HELP” Or other distress Message.

Power cord: The Mobile Safety Light will be powered by a power cord that will be plugged into the Cigarette Lighter Outlet.

Backup Battery: The Mobile Safety Light will be equipped a six volt battery that will operate The Mobile Safety Light when the pedestrian's 12 volt battery is dead.

Off/On Switch: The Mobile Safety Light will have an off/on switch to control the flow of Current after the power cord has been plugged into the Cigarette Lighter Outlet.

What is claimed is:

1. The Mobile Safety Light of claim 1 wherein: is used when a pedestrian is having vehicular problem.

2. The Mobile Safety Light of claim 2 wherein: uses L.E.D. (Lighted Emitting Diodes) as visible distress display.

3. The Mobile Safety Light of claim 3 wherein: L.E.D. (Lighted Emitting Diodes) message such as SEND HELP.

4. The Mobile Safety Light of claim 3 wherein: L.E.D. (Lighted Emitting Diodes) message such as SEND HELP can be any native language.

5. The Mobile Safety Light of claim 4 wherein: L.E.D. (Lighted Emitting Diodes) message such as Directional Arrows.

6. The Mobile Safety Light of claim 5 wherein L.E.D. (Lighted Emitting Diodes) message such as Directional Arrows to go in left or right direction.

7. The Mobile Safety Light of claim 6 wherein: bungee or elastic cord will be one form of securing the Mobile Safety Light to the vehicle.

8. The Mobile Safety Light of claim 7 wherein: adjustable legs for more sight distant.

9. The Mobile Safety Light of claim 8 wherein: suction cups or magnets at the end of the adjustable legs to secure the Mobile Safety Light and to protect the paint.

10. The Mobile Safety Light of claim 9 wherein: a power cord the will be plugged into the cigarette outlet.

11. The Mobile Safety Light of claim 10 wherein: a 6 volt Battery is used when a pedestrian's vehicle has vehicular problem but their vehicle has no power.
